(19) United States
(12) Patent Application Publication
(10) Pub. No.: US 2015/0367947 A1
(43) Pub. Date: Dec. 24, 2015

(54) AIRCRAFT PROPULSION ASSEMBLY COMPRISING AT LEAST ONE BRUSH SEAL RESISTANT TO HIGH-TEMPERATURE

(71) Applicants: Airbus Operations SAS, Toulouse (FR); AIRBUS SAS, Blagnac (FR)

(72) Inventors: Virginie Audart-Noel, Pujaudran (FR); Benoit Letay, Bouloc (FR); Loïc Dussol, Toulouse (FR); Michael Galinier, Blagnac (FR); Nicolas Viallet, Pibrac (FR); Laurent Cazeaux, Toulouse (FR); Benjamin Vignoboul, Montauban (FR)

(73) Assignees: Airbus Operations SAS, Toulouse (FR); AIRBUS SAS, Blagnac (FR)

(21) Appl. No.: 14/762,085

(22) PCT Filed: Jan. 20, 2014
(86) PCT No.: PCT/FR2014/050104

§ 371 Date: Jul. 20, 2015

(30) Foreign Application Priority Data
Jan. 22, 2013 (FR) 13 50551

(51) Int. Cl. B64D 27/26; B64D 29/02; B64D 45/00; B64D 27/18

(52) U.S. Cl. CPC B64D 27/26; B64D 27/18; B64D 29/02; B64D 45/00; B64D 2045/009

(57) ABSTRACT

A seal is interposed between two surfaces of an aircraft propulsion assembly. The seal includes at least two layers each comprising a plurality of strands made of a heat-resistant material, the strands of a first layer being oriented in a first orientation and the strands of a second layer being oriented in a second orientation different than the first orientation.

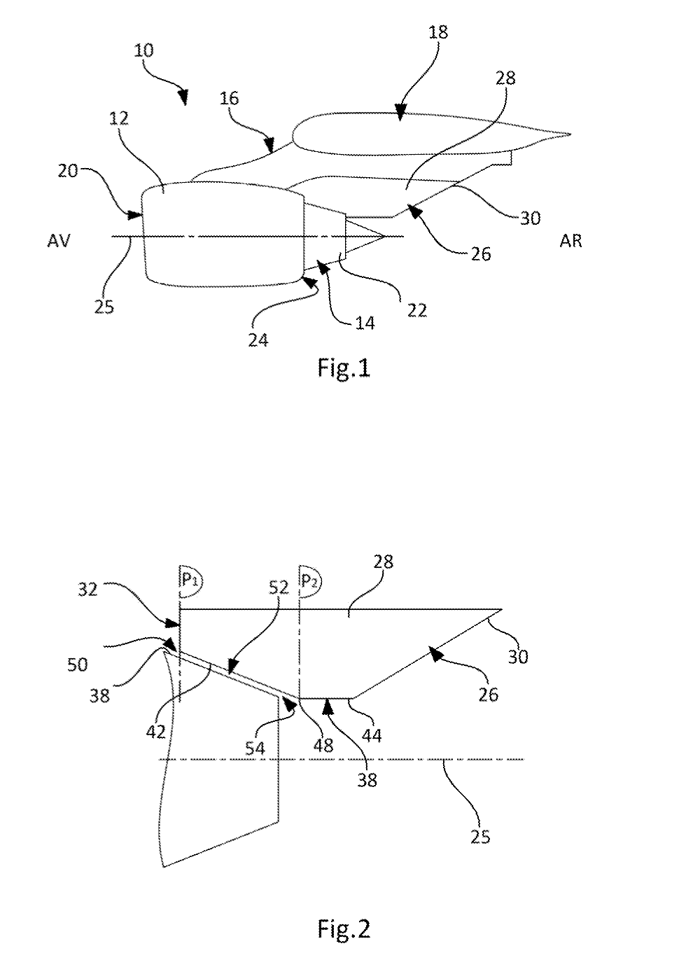

The present invention relates to an aircraft propulsion assembly incorporating at least one brush seal resistant to high-temperature. According to one application, the seal of the invention may be positioned between a lower rear fairing of a pylon and an engine supported by said pylon. As illustrated in FIG. 1, an aircraft engine 10 comprises a nacelle 12 in which a motor unit 14 is arranged substantially concentrically. It is connected by a pylon 16 to a wing structure 18 of an aircraft.

The nacelle 12 at the front comprises an air intake 20, a first part of the in-coming air flow, referred to as the primary flow, passing through the engine unit 14 to participate in combustion and be ejected at the rear via a jet pipe 22, the second part of the air flow, referred to as the secondary flow, being entrained by a fan and flowing along an annular duct delimited by the interior wall of the nacelle and the exterior wall of the motor unit to be ejected at the rear via an annular outlet 24.

For the remainder of the description, the longitudinal direction corresponds to the axis of rotation of the engine unit, referenced 25 in FIG. 1. The front and the rear of the nacelle are defined according to the flow of air passing through the nacelle in the flight phase and in FIG. 1 are referenced AV and AR respectively.

The pylon 16 amongst other things transmits the thrust force of the engine to the rest of the aircraft and allows networks (fuel, electrical, hydraulic and air networks) to pass between the engine and the aircraft.

This pylon 16 comprises an outer casing of aerodynamic shape that allows it not to have too greater an effect on aircraft drag. This casing comprises a lower rear fairing referred to hereinafter as the APF (Aft Pylon Fairing) 26. This APF 26 essentially performs two functions:
the first function is to form a thermal or fire barrier to protect the rest of the pylon 16 and wind structure 18 which are made of materials (for example composite materials) incapable of withstanding high temperatures such as those of the hot gases leaving the jet pipe 22.
the second function is to ensure the aerodynamic continuity between the outlets 22 and 24 of the engine and the pylon.

As illustrated in FIGS. 1 and 2, the APF is positioned in the continuation of the annular outlet 24 of the engine.

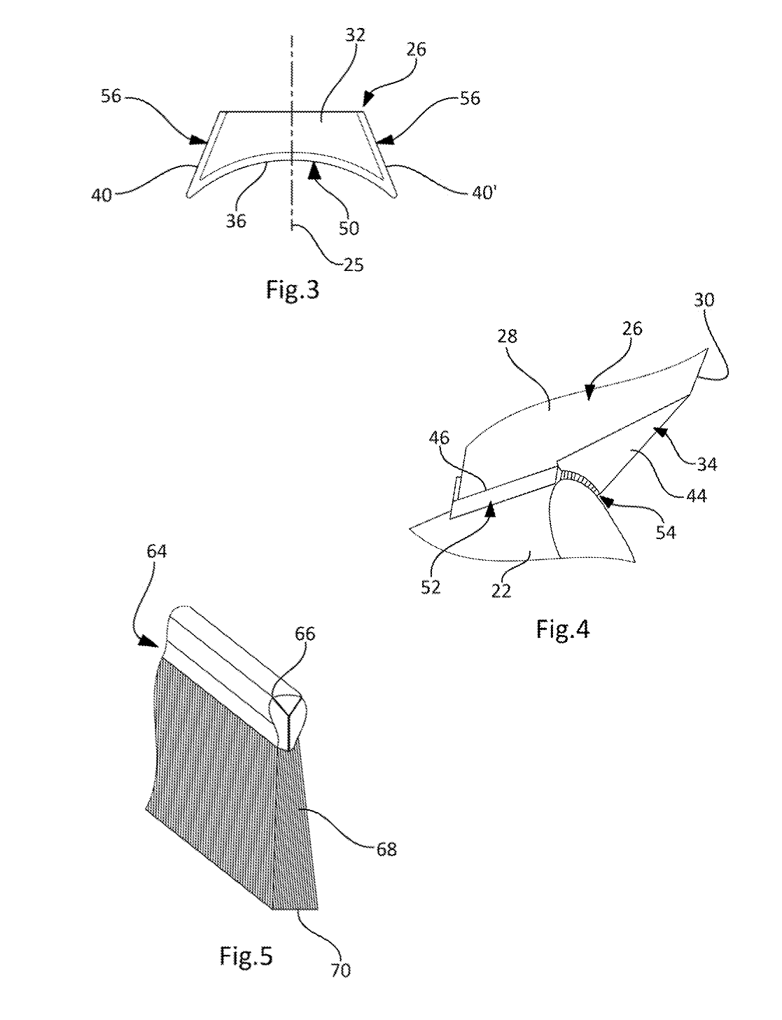

It comprises a structure (not depicted) supporting two lateral walls 28 which meet at the rear at an intersection 30 that forms a trailing edge, a front panel 32 (visible in FIG. 3) and a floor 34 (visible notably in FIG. 4).

The front panel 32 is arranged in a plane P1 approximately perpendicular to the longitudinal direction 25. It comprises a lower edge 36 with a radius of curvature suited to that of the exterior surface 38 of the jet pipe so as to be closely spaced away from said exterior surface 38 over the entire length thereof. The front panel 32 comprises two lateral edges 40, 40′ which extend from each end of the lower edge 36. These lateral edges 40, 40′ are arranged facing parts of the nacelle and, more particularly, parts of the nacelle that are mobile (on the ground) such as the thrust reverser cowls (not depicted).

The floor 34 comprises a front part 42 in the form of a frustoconical portion parallel to the exterior surface 38 of the jet pipe 42 and closely spaced therefrom, and a rear part 44 which extends the outlet of the jet pipe and connects the lower edges of the lateral walls 28.

The front part 42 comprises a front edge positioned just behind the front panel 32, two lateral edges parallel to the lower edges 46 of the lateral walls 28.

The front part 42 and the rear part 44 are produced as a single piece and separated by an intersection 48 positioned in a plane P2 approximately perpendicular to the longitudinal direction 25.

Because of the certification standards, notably those relating to the “fire” zones, a barrier needs to be provided at the periphery of the front part 42 of the floor 34.

This barrier comprises a front seal 50 at the lower edge 36 of the front panel 32, which essentially performs the fire break function, a lateral seal 52 at the lower edge 46 of each lateral wall 28 which limits the circulation of air, and a rear seal 54 at the intersection 48 of the floor, which limits the risks of gases leaving the jet pipe recirculating between the APF and the jet pipe. According to one embodiment, the lateral edges 40, 40′ of the front panel 32 each support a seal 56.

According to one embodiment, the front seal 50 is made of silicone elastomer. It takes the form of a sausage. Advantageously, the seals 50 and 56 form just one seal, the seal 50 extending at the lateral edges 40, 40′.

As an alternative, the front seal 50 comprises turkey feathers (a seal with metal blades arranged edge to edge) along the length of the front seal 50. In that case, the front seal 50 comprises a base fixed to the lower edge 36 of the front panel, and a plurality of “turkey feathers” one end of which is secured to the base and the curved other end of which is in contact with the exterior surface of the jet pipe.

According to one embodiment, each lateral seal 52 takes the form of an elastomer strip of which one edge is connected to the lower edge 46 of the lateral wall 28 and of which the other edge bears against the exterior surface 38 of the jet pipe.

According to one embodiment, the rear seal 54 takes the form of turkey feathers (a seal made up of metal strips arranged edge to edge).

Given the environments in which they are situated, these various seals 50, 52, 54 need to act as barriers despite the wide amplitude of movements between the APF and the engine and significant temperature variations.

Another constraint to which they are subjected is vibrational phenomena. Finally, the temperature gradients across the seal may be great when the seal is used as a pressure barrier.

Even though the seals used are satisfactory on a functional level, some seals may wear prematurely. Thus, elastomer seals may become burnt in certain areas, notably areas close to the hot zone of the engine because of the high temperatures. In addition, turkey feather seals may crack or break, notably at the curved ends, because of friction against the jet pipe.

Given these risks of wear, it is necessary for these seals to be inspected and changed regularly.

The present invention seeks to overcome the disadvantages of the prior art.

To this end it proposes the use, by way of barrier, of a seal comprising at least two layers each comprising a plurality of strands (68) made of a heat-resistant material, the strands of a first layer being oriented in a first orientation and the strands of a second layer being oriented in a second orientation different than the first orientation.

For preference, these strands are made from a metallic alloy based on nickel or on cobalt.

This type of seal performs the barrier function even in the presence of a high amplitude of movement between the components of a propulsion assembly, such as the APF and the engine. Unlike the seals of the prior art, this kind of seal has better resistance to wear, making it possible to increase the time between inspections and the time between changes. As a result, the seal according to the invention allows aircraft operating costs to be reduced.

According to a first alternative form, the seal comprises at least one brush seal comprising a base secured to the first surface and a plurality of strands of which a first end is fixed to the base and of which a second end is free and in contact with the second surface. For preference, the strands are inclined with respect to the second surface in the same direction in a plane containing the length of said seal. Advantageously, the brush seal comprises at least one layer of strands that are inclined in a first direction and at least one layer of strands that are inclined in a second direction opposite to the first.

This alternative form is more particularly suited to performing the function of the front seal provided at the lower edge of the front panel of the APF.

According to another alternative form, a seal comprises two brush seals, the base of the first seal being secured to a first surface and the base of the second seal being secured to the second surface, the strands of the first brush seal being pressed firmly against the strands of the second brush seal.

This alternative form is more particularly suited to performing the function of a seal provided at a later edge of the front panel of the APF.

According to another alternative form, a seal comprises several brush seals the bases of which are alternately connected to one or other of the surfaces.

This alternative form is more particularly suited to performing the function of the rear seal provided at the floor of the APF facing the trailing edge of the jet pipe.

According to another alternative form, a seal comprises two brush seals, each secured to one of the surfaces, arranged facing one another so that the free ends of the strands of one of the two brush seals nest between the strands of the other brush seal.

This alternative form is more particularly suited to performing the function of a seal provided at the lower edge of a lateral wall of an APF.

Other features and advantages will emerge from the description which will follow of the invention, which description is given solely by way of example with reference to the attached drawings in which:

FIG. 1 is a side view of an aircraft engine,

FIG. 2 is a schematic depiction of the rear end of a jet pipe and of an APF,

FIG. 3 is a front view of a front panel of an APF according to the prior art,

FIG. 4 is a perspective view of part of an APF according to the prior art,

FIG. 5 is a perspective view of a brush seal according to the invention,

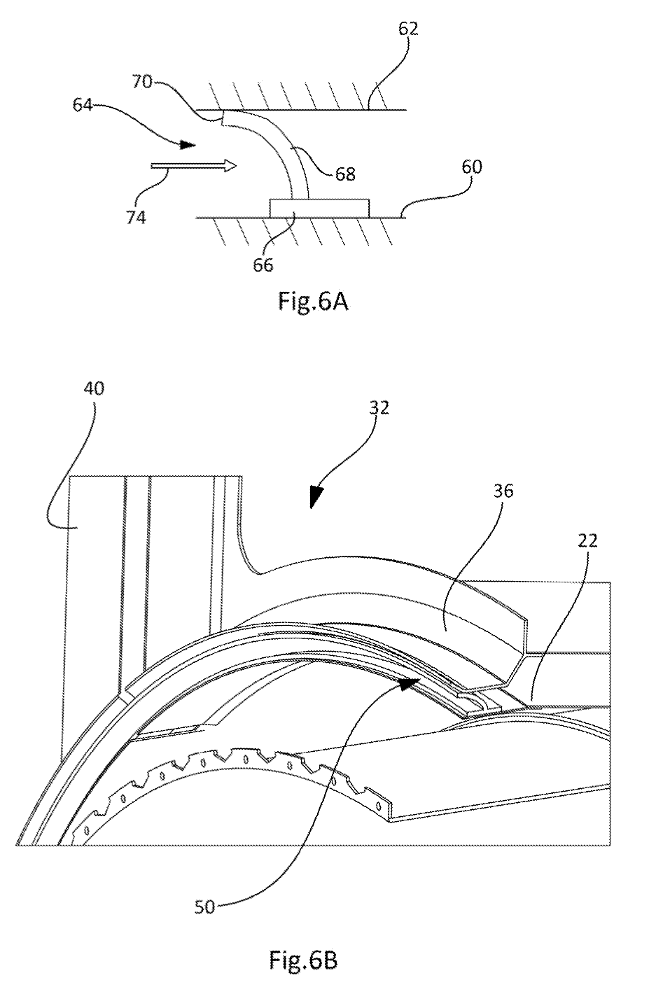

FIG. 6A is a section illustrating a seal according to a first alternative form of the invention,

FIG. 6B is a perspective view of a front panel of an APF using a seal according to the alternative form illustrated in FIG. 6A,

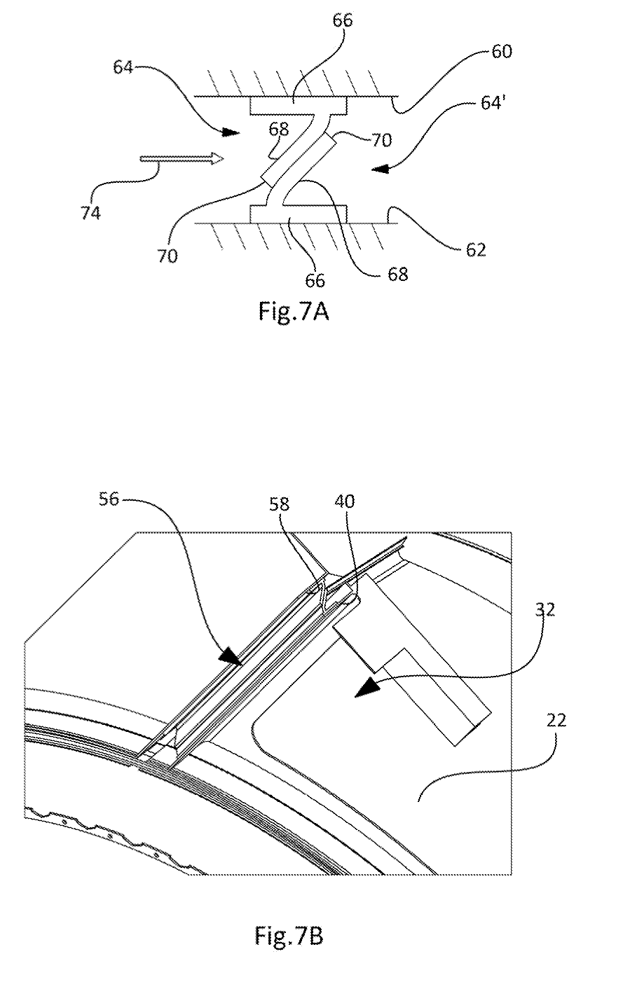

FIG. 7A is a section illustrating a seal according to a second alternative form of the invention,

FIG. 7B is a perspective view of a front panel of an APF using a seal according to the alternative form illustrated in FIG. 7A,

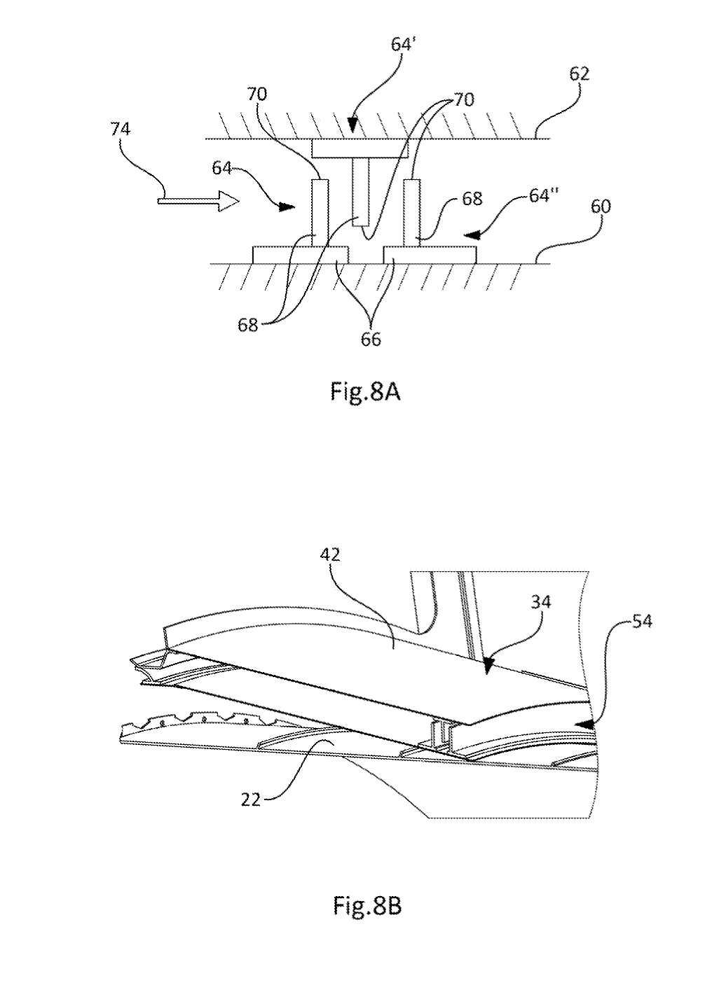

FIG. 8A is a section illustrating a seal according to a third alternative form of the invention,

FIG. 8B is a perspective view of the front part of the floor of an APF using a seal according to the alternative form illustrated in FIG. 8A,

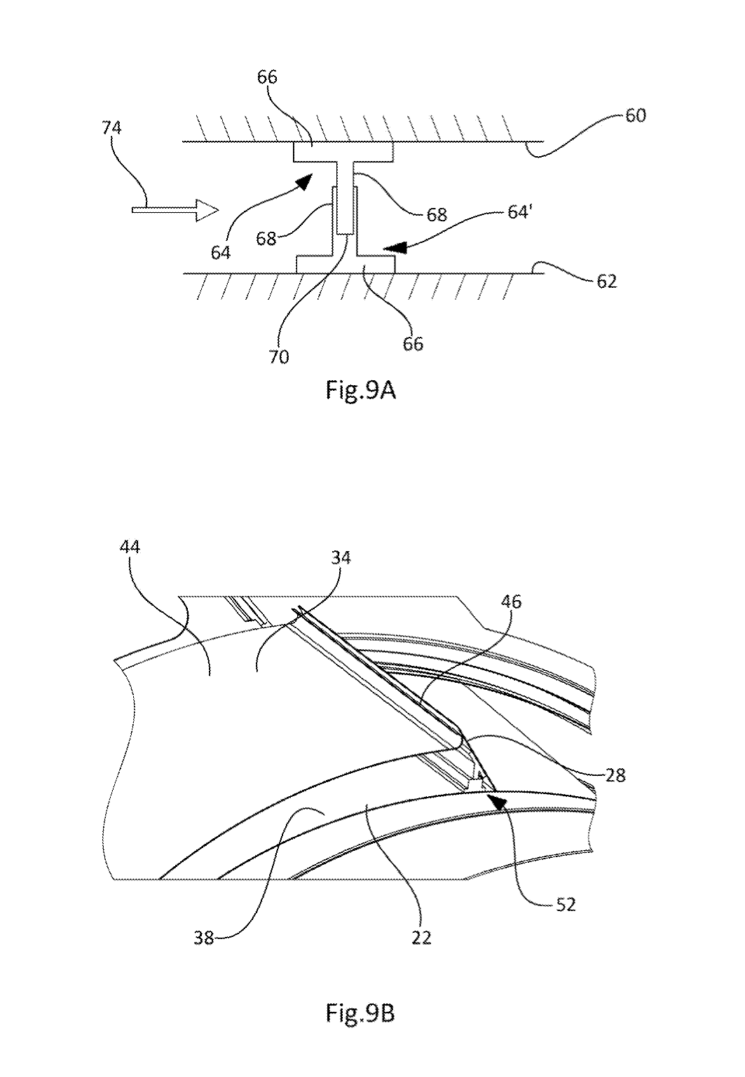

FIG. 9A is a section illustrating a seal according to a fourth alternative form of the invention,

FIG. 9B is a perspective view of the front part of the floor of an APF using a seal according to the alternative form illustrated in FIG. 9A,

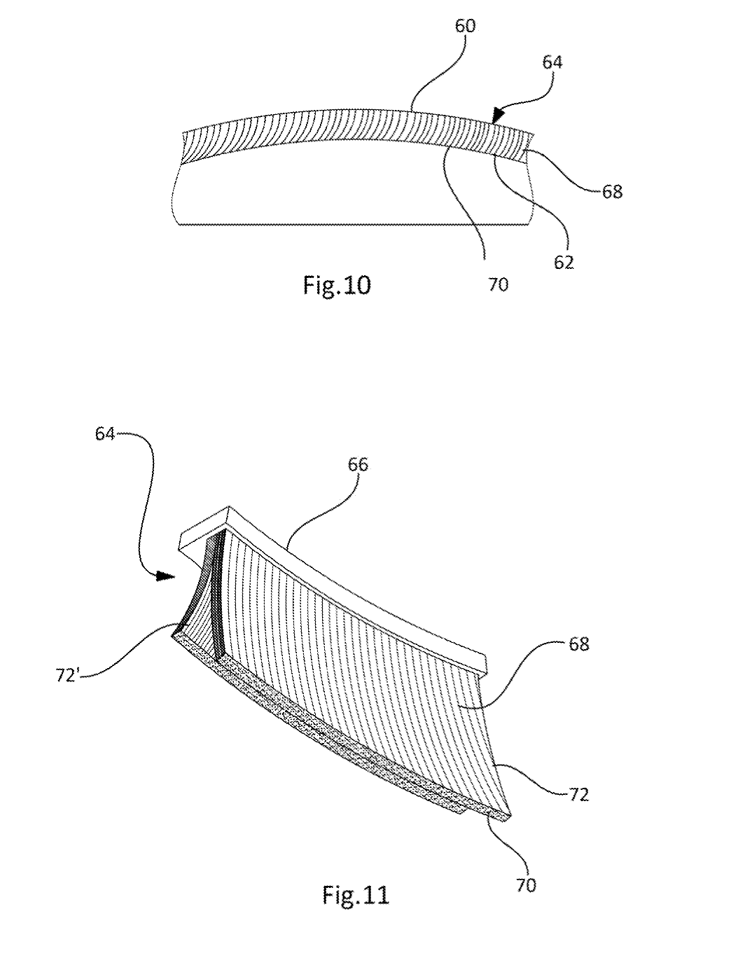

FIG. 10 is a front view of a seal illustrating a way of installing the strands, and

FIG. 11 is a perspective view of a seal illustrating another way of installing the strands.

Views 6B, 7B, 8B, 9B depict a lower rear fairing of a pylon, or APF, said pylon supporting an engine comprising an engine unit arranged inside a nacelle. For the purposes of the present application, a propulsion assembly means all of the elements of an engine (engine unit/nacelle) and of the pylon supporting the engine.

Elements identical to the prior art are referenced in the same manner. Thus the APF 26 comprises a structure (not depicted) supporting two lateral walls 28, a front panel 32 and a floor 34.

As illustrated in FIG. 6B, the front panel 32 comprises a lower edge 36. A front seal 50 is interposed between the lower edge 36 and the jet pipe 22.

As illustrated in FIG. 7B, the front panel 32 comprises at least one lateral edge 40. A seal 56 is interposed between the lateral edge 40 and part 58 of the nacelle, for example a part which on the ground can be moved, such as a thrust reverser cowl.

As illustrated in FIG. 8B, the floor 34 comprises a front part 42 arranged facing an exterior surface 38 of the jet pipe 22 of the engine. A rear seal 54 is interposed between the floor 34 and the exterior surface of the trailing edge of the jet pipe 22.

As illustrated in FIG. 9B, the APF comprises lateral walls of which the lower ends are closely spaced from the exterior surface of the jet pipe 22. A lateral seal 52 is interposed between the lower edge 46 of each lateral wall 28.

Whatever its position, a seal 50 to 56 is interposed between first surface 60 belonging to the APF (or to the engine) and a second surface 62 belonging to the engine (or to the APF).

According to the invention a seal comprises at least one brush seal 64 comprising a plurality of strands made of a heat-resistant material, as illustrated in FIG. 5.

The longest dimension of the brush seal corresponds to its length and the shortest dimension corresponds to its width.

A brush seal 64 comprises a base 66 secured to one of the two surfaces 60 and 62 and a plurality of strands 68 of which a first end is fixed to the base 66 and of which the second end 70 is free.

The strands 68 are filiform elements.

Advantageously a brush seal 64 comprises several strands across its width. This configuration reinforces the barrier that the seal forms.

For preference, these strands 68 are made from a metallic alloy based on nickel or on cobalt. This solution makes it possible to obtain better resistance to high temperatures.

The base 66 of the brush seal may be made of metal or some other material. According to one embodiment it comprises two parallel flanges extending along the length of the seal and gripping the ends of the strands. According to one embodiment, the base 66 is secured to one of the surfaces 60, 62 by any suitable means, such is used in screws for example. As an alternative, the base and the surface to which it is connected are produced as a single piece.

In certain alternative forms, the base 66 is secured to a first surface 60 and the free ends 70 are distant from the second surface 62, as illustrated in FIG. 8A.

In other alternative forms, the base 66 is secured to a first surface 60 and the free ends 70 are in contact with the second surface 62, as illustrated for example in FIG. 6A. In this case, hot oxidation of the strands makes it possible to reduce friction.

Advantageously, when the free ends of the strands are in contact with a surface, the strands 68 are not oriented perpendicular to said surface but are inclined, in a plane containing the length of the seal, as illustrated in FIG. 10. Thus, as the two surfaces move closer together, the strands are always inclined in the same directional sense. This configuration makes it possible to prevent the strands becoming inclined in the opposite directional sense as the surfaces are moving closer together and parting, leaving them between a space which is synonymous with a leak.

According to another alternative form illustrated in FIG. 11, the brush seal 64 comprises at least one layer 72 of strands which are inclined in a first direction in the sense of the length of the seal and at least one layer 72′ of strands which are inclined in a second direction contrary to the first direction in the lengthwise directional sense of the seal. This configuration makes it possible to obtain a barrier that is sealed at each end.

By way of example, the strands of the layer 72 are inclined by an angle making +20° with respect to the normal whereas the strands of the layer 72′ are inclined by an angle making −20° with respect to the normal.

According to a first alternative form illustrated in FIG. 6A, a seal comprises a single brush seal 64. In that case, the free ends 70 of the strand 68 are in contact with one of the two surfaces. For that purpose the height of the brush seal 64 is greater than the maximum distance separating the two surfaces 60 and 62.

As illustrated in FIG. 6A, the brush seal 64 forms a barrier secant to the direction of the flow 74. According to a first arrangement illustrated in FIG. 6A, the free ends 70 of the strands are oriented in opposite directional senses with respect to the direction of the flow 74. In that case, the pressure difference will have a tendency to press the free ends 70 of the strands firmly against the surface 62 thereby improving sealing.

According to another arrangement, the free ends 70 of the strands are oriented in the same directional sense as the direction of the flow 74. In that case, the barrier formed by the brush seal may act as a valve. Thus, in the event of an overpressure, the strands 68 will incline to allow the surplus pressure to pass, and will then return to their initial position.

This alternative form makes it possible to obtain a fire barrier and, according to the orientation of the ends of the strands, either a pressure-proof barrier or a barrier that acts as a relief valve.

According to one application, this alternative form is particularly well suited to forming the front seal 50 of the

APF, as illustrated in FIG. 6B. In that case, the case of the brush seal is secured to the engine and, more particularly, to the jet pipe 22, and the free ends 70 of the strands are in contact with the floor of the APF and oriented toward the front of the nacelle.

According to another alternative form illustrated in FIG. 7A, a seal comprises two brush seals 64 and 64′, the base of the first seal 64 being secured to a first surface 60 and the base of the second seal 64′ being secured to the second surface 62. For preference, the first ends of the strands 68 of a first brush seal 64 are offset rearward with respect to the first ends of the strands 68 of the second brush seal 64′ and the strands 68 of the first brush seal 64 are placed in front of the strands of the second brush seal 64′ so that the strands of the first brush seal 64′ are pressed firmly against the strands of the second brush seal 64′.

As illustrated in FIG. 7A, the brush seals 64, 64′ form a barrier secant to the direction of a flow 74. This alternative form makes it possible to obtain both a fire barrier and a pressure tight barrier.

In one application, this alternative form is particularly well suited to forming a seal 56 intended to be interposed between a lateral edge of the front panel of an APF and a part of the nacelle such as a thrust reverser cowl, as illustrated in FIG. 7B.

In another alternative form illustrated in FIG. 8A, the seal comprises three brush seals 64, 64′, 64″ which are offset in the direction of the flow 74. According to this alternative form, the brush seals 64, 64′, 64″ have a height that is less than the distance separating the surfaces 60 and 62.

The bases of the brush seals are alternately connected to one or other of the surfaces 60 and 62. Thus, the first brush seal 64 is connected to the first surface 60, the second brush seal 64′ is connected to the second surface 62, the third brush seal 64″ is connected to the first surface 60. This configuration makes it possible to form a leakage path.

Contrary to the preceding alternative forms, this alternative form makes it possible to obtain a fire seal but is unable to form a pressure barrier.

As an alternative, according to this alternative form, the seal may comprise two brush seals or more than three brush seals.

According to one application, this alternative form is more particularly suited to forming a rear seal 54 of an APR 26, as illustrated in FIG. 8B. In this case, the first brush seal 64 is secured to the jet pipe 22, the second brush seal 64′ is secured to the floor 34 of the APF and the third brush seal 64″ is secured to the jet pipe 22.

According to another alternative form illustrated in FIG. 9A, a seal comprises two brush seals 64 and 64′, each one secured to one of the surfaces 60, 62 arranged facing one another such that the free ends 70 of the strands of one of the two brush seals nest between the strands of the other brush seal.

In this alternative form, the height of the two brush seals is less than the maximum distance separating the two surfaces 60 and 62, the sum of the heights nevertheless being greater than the minimum distance between the two surfaces 60 and 62. According to one embodiment, a first seal 64 is secured to a first surface 60 and the free ends 70 of its strands 68 nest between the strands 68 of the second brush seal secured to the second surface 62.

This alternative form makes it possible to obtain both a fire barrier and a pressure tight barrier.

According to one application, this alternative form is more particularly suited to forming a lateral seal 52 of the APF, as illustrated in FIG. 9B. In this case, a first brush seal 64 is secured to the lower end of a lateral wall 28 of the APF and a second brush seal 64′ is secured, facing it, to the jet pipe 22.

Whatever the alternative form, the seal comprises at least two layers each one comprising a plurality of strands made from a heat-resistant material, the strands of a first layer being oriented at a first orientation and the strands of a second layer being oriented at a second orientation different than the first orientation.

According to the invention, an orientation is characterized by a direction, namely the direction of the straight line passing through the ends of each strand and by the sense of that direction, namely the position of the end of the strand connected to the base with respect to the free end thereof. According to an alternative form illustrated in FIG. 11, a brush seal comprises two layers of strands which are connected to the same base 66. In this alternative form, the strands of the two layers have different directions.

According to other alternative forms illustrated in FIGS. 7A, 7B, 8A, 8B, 9A, 9B, each layer is connected to a distinct base 66 and each of them forms a distinct brush seal. In that case, the seal comprises several brush seals, each of them comprising at least one layer of strands, at least two brush seals having layers of strands with different directional senses.

Although described with respect to an application to an interface between the APF and the engine, the invention is not in any way restricted to this zone. It may be suitable for other regions of the propulsion assembly which are subjected to high temperatures in excess of 100° C., such as between the thrust reverser cowl and a bifurcation extending between the engine unit and a nacelle.

1. An aircraft propulsion assembly comprising:
a pylon with a lower rear fairing;
an engine; and
at least one seal interposed between a surface of said lower rear fairing and a surface of said engine,
wherein said seal comprises at least two layers each comprising a plurality of strands made of a heat-resistant material, the strands of a first layer being oriented in a first orientation and the strands of a second layer being oriented in a second orientation different than the first orientation.

2. The aircraft propulsion assembly as claimed in claim 1, further comprising at least one brush seal comprising a base secured to the first surface and a plurality of strands of which a first end is fixed to the base and of which a second end is free and in contact with the second surface.

3. The aircraft propulsion assembly as claimed in claim 2, wherein the strands are all inclined in the same direction in a plane containing the length of said seal.

4. The aircraft propulsion assembly as claimed in claim 1, wherein the seal comprises at least one layer of strands inclined in a first direction and at least one layer of strands inclined in a second direction contrary to the first orientation.

5. The aircraft propulsion assembly as claimed in claim 1, wherein the seal comprises a single brush seal of which the strands comprise free ends in contact with a surface.

6. The aircraft propulsion assembly as claimed in claim 5, wherein the brush seal is secant to a flow and the free ends of the strands are oriented in an opposite directional sense with respect to the direction of the flow.

7. The aircraft propulsion assembly as claimed in claim 5, wherein the brush seal is secant to a flow and the free ends of the strands are oriented in the same directional sense as the direction of the flow.

8. The aircraft propulsion assembly as claimed in claim 2, wherein said lower rear fairing comprises a front panel with a lower edge facing an exterior surface of a jet pipe of the engine, and
wherein the brush seal has a base secured to the exterior surface of the jet pipe and the strands have free ends in contact with the lower edge of the front panel of the lower rear fairing.

9. The aircraft propulsion assembly as claimed in claim 1, wherein the seal comprises several brush seals.

10. The aircraft propulsion assembly as claimed in claim 9, wherein the seal comprises two brush seals, a first seal with a base secured to a first surface and a second seal with a base secured to a second surface, the strands of the first brush seal being pressed firmly against the strands of the second brush seal.

11. The aircraft propulsion assembly as claimed in claim 10, wherein the brush seals are secant to a flow and the strands of the brush seal in contact with the flow have free ends oriented in the opposite directional sense with respect to the direction of the flow.

12. The aircraft propulsion assembly as claimed in claim 9, wherein said lower rear fairing comprises a front panel with at least one lateral edge facing part of the engine, and
wherein the base of the first seal is secured to the part of the engine and the base of the second seal is secured to the lateral edge of the front panel of the lower rear fairing.

13. The aircraft propulsion assembly as claimed in claim 9, wherein the seal comprises several brush seals with bases alternately connected to one or other of the surfaces.

14. The aircraft propulsion assembly as claimed in claim 13, wherein said propulsion assembly comprises a pylon with a lower rear fairing comprising a floor positioned facing an exterior surface of a jet pipe of the engine, said jet pipe comprising a trailing edge,
Wherein at least one brush seal has a base secured to the floor and at least one brush seal has a base secured to the exterior surface of the jet pipe, said seals being positioned near the trailing edge of the jet pipe.

15. The aircraft propulsion assembly as claimed in claim 9, wherein the seal comprises two brush seals each one secured to one of the surfaces, arranged facing one another so that the strands of one of the two brush seals have free ends which nest between the strands of the other brush seal.

16. The aircraft propulsion assembly as claimed in claim 15, wherein said propulsion assembly comprises a pylon with a lower rear fairing comprising lateral walls with lower ends closely spaced with an exterior surface of a jet pipe of the engine, and
wherein the base of a first brush seal is secured to the lower edge of a lateral wall and the base of the second brush seal is secured to the exterior surface of the jet pipe.
